(19) United States
(12) Patent Application Publication
(10) Pub. No.: US 2024/0208711 A1
(43) Pub. Date: Jun. 27, 2024

(54) Impact Resistant Casing

(71) Applicant: Johnny L. Johnson, North Little Rock, AR (US)

(72) Inventor: Johnny L. Johnson, North Little Rock, AR (US)

(21) Appl. No.: 18/088,268

(22) Filed: Dec. 23, 2022

(51) Int. Cl. B65D 81/03; B65D 85/30

(52) U.S. Cl. CPC B65D 81/03; B65D 85/30

(57) ABSTRACT

The disclosure is the only product of its kind that is specifically developed to protect frail and delicate decorative accessories from being broken upon unplanned falls and/or abrasive contact. This unprecedented product is uniquely designed with durable, high-quality materials to ensure long-term sustainability and can be used on a wide variety of different lamp and vase models and sized to meet diverse consumer needs.

### BACKGROUND

Decorative options such as lamps and vases can be easily tipped over and shattered due to their frailty. Not only can this be a frustrating occurrence, for owners, as clean-up can be incredibly time-consuming and tedious but rare or sentimental items can be very difficult to replace and/or repair post-incident. There have been no products available as original equipment or as an aftermarket to address this problem.

An apparatus to prevent decorative lamps and vases from shattering when tipped over is not being met by any known device or system at present. There have been no products available as original equipment or as an aftermarket to address this problem either.

### SUMMARY OF THE INVENTION

The main purpose of the impact resistant casing is to provide users with a safeguarding cover for vases and lamps in order to prevent breakage.

A guard for a pottery is disclosed including a wrap comprising a base and a neck and configured to conform to a surface of the pottery from the base to the neck inclusive thereof, a base ring and a neck ring configured to overlap the wrap respectively at the base and the neck and to provide cushion to the base and neck of the pottery, and a plurality of clamps placed on the base ring and the neck ring configured to fasten the respective ring to the pottery and secure the wrap to the pottery.

### BRIEF DESCRIPTION OF THE DRAWINGS

FIG. 1 is a top perspective view of the Impact Resistant Casing and device on a lamp holder and a lamp shade in accordance with an embodiment of the present disclosure.

FIG. 2 is a top perspective view of the Impact Resistant Casing and device on a vase in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the word ‘pottery’ includes a lamp holder, a vase, a circular or semicircular piece or ceramic art, an earthenware glass, cup, bowl, pitcher, and the like made out of ceramics, clay, cement, glass, and other materials common to those learned and skilled in the art. Additionally, the term ‘wrap’ is synonymous with the term ‘casing’ and ‘cover’ as used explicitly and implicitly inferred or taught herein.

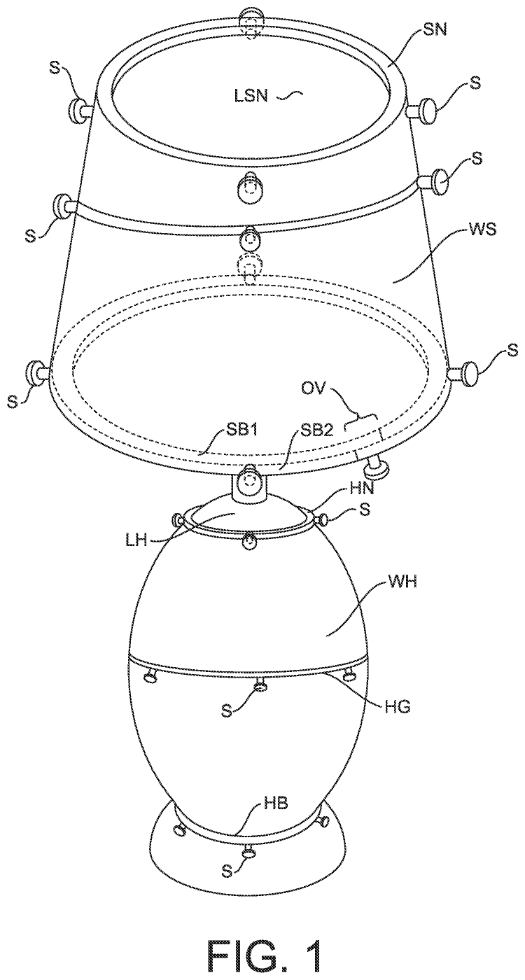

FIG. 1 is a top perspective view of the Impact Resistant Casing and device on a pottery including a lamp holder and a lamp shade showing: top ring with fastener referenced as SN shade neck ring, screw clamp to fasten respective rings referenced as S, Over shade protector referenced as WS wrap shade, ceramic or lamp holder referenced as LH, the wrap for the lamp holder as WH, the holder girth HG or girth ring, the holder base ring HB, the lamp shade LSN, the concentric and overlapping rings SB1 and SB2 and the overlap portion thereof OV and the lamp holder neck ring HN in accordance with an embodiment of the present disclosure. The depiction also includes the lamp shade girth ring SG.

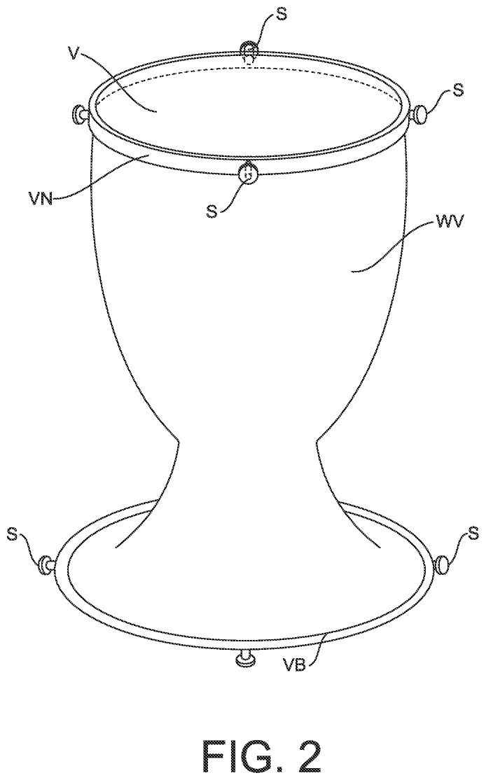

FIG. 2 is a top perspective view of the Impact Resistant Casing and device on a vase showing: top ring with fastener referenced as VN for vase neck, screw clamp to fasten ring referenced as S, ceramic part V for vase, wrap protector referenced as WV, vase base ring VB and a vase girth ring (not depicted for aesthetic reasons but is inclusive thereof) in accordance with an embodiment of the present disclosure.

The present disclosed impact resistant casing, also known as “The Lamp and Vase Protector”, offers a modern accessory that prevents lamps and vases from breaking when they are accidentally dropped or tipped over, therefore, allowing users to better secure their belongings at all times. Meant to complement the average design of a lamp or vase, the Lamp and Vase Protector introduces a novel protector that can be conveniently fastened onto said objects. Users simply place the base of the lamp or vase into the center of the protector which possesses a flexible material enabling users to easily pull it up and over the sides of the object where it would stay in place via a non-slip material. Furthermore, if users seek to cover the lamp shade alone, this adaptable buffer comes with a large ring that secures it to the item when placed over the top, offering additional support. This innovative, top-quality product ensures a fully operational, safeguarding cover that protects family heirlooms without compromising the aesthetic and serves to eliminate the need for users to replace or repair their items due to random accidental drops and/or contact.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A guard for a pottery, comprising:
a wrap configured to conform to a surface of the pottery from a base to a neck inclusive thereof;
a base ring and a neck ring configured to overlap the wrap respectively at the base and the neck and to provide cushion to the base and neck of the pottery; and
a plurality of screw clamps received via threads through the base ring and through the neck ring and up against the wrap to the pottery to fasten the respective ring to the pottery and to secure the wrap to the pottery.

2. The pottery guard of claim 1, wherein the pottery includes a lamp holder and the pottery base is a holder base and the pottery neck is a holder neck.

3. The pottery guard of claim 1, wherein the pottery includes a shade and the lamp base is a shade base and the lamp neck is a shade neck.

4. The pottery guard of claim 1, wherein the clamps are threaded bolts received into threaded holes defined in the base ring and the neck ring.

5. The pottery guard of claim 1, wherein the clamps are threaded bolts having knurled heads and received into threaded holes defined in the base ring and the neck ring.

6. (canceled)

7. (canceled)

8. (canceled)

9. The pottery guard of claim 1, wherein the pottery includes a lamp holder and a lamp shade and a holder wrap and a shade wrap.

10. The pottery guard of claim 9, wherein the holder wrap comprises silicon.

11. The pottery guard of claim 9, wherein the shade wrap comprises a stretchy fabric comprising spandex.

12. The pottery guard of claim 1, wherein the base ring and the neck ring comprise a metal.

13. The pottery guard of claim 1, wherein the base ring and the neck ring comprise an elastic material.

14. The pottery guard of claim 1, wherein the base ring and the neck ring each comprise a concentric expansion ring held in place by one of the plurality of clamps.

15. The pottery guard of claim 1, further comprising a girth ring configured to encircle a girth of the pottery between the base ring and the neck ring.

16. The pottery guard of claim 1, wherein the wrap is an impact resistant casing.

17. The pottery guard of claim 1, wherein the pottery is a vase.
